(19) United States
(12) Patent Application Publication
(10) Pub. No.: US 2024/0187976 A1
(43) Pub. Date: Jun. 6, 2024

(54) TERMINAL DEVICE, UNIFIED DATA MANAGEMENT NETWORK ELEMENT, AND FIRST NETWORK ELEMENT

(71) Applicant: GUANGDONG OPPO MOBILE TELECOMMUNICATIONS CORP., LTD., Dongguan (CN)

(72) Inventors: Fei LU, Dongguan (CN); Zhe FU, Dongguan (CN)

(73) Assignee: GUANGDONG OPPO MOBILE TELECOMMUNICATIONS CORP., LTD., Dongguan (CN)

(21) Appl. No.: 18/396,490

(22) Filed: Dec. 26, 2023

Related U.S. Application Data
(63) Continuation of application No. PCT/CN2021/104361, filed on Jul. 2, 2021.

(51) Int. Cl. H04W 48/18; H04W 60/04; H04W 84/04

(52) U.S. Cl. CPC H04W 48/18; H04W 60/04; H04W 84/042

(57) ABSTRACT

A terminal device, a unified data management network element, and a first network element are provided. The terminal device includes a processor and a memory. The memory is configured to store a computer program, and the processor is configured to call and run the computer program stored in the memory to perform: determining, by the terminal device, a first Public Land Mobile Network PLMN according to first slice information, and accessing the first PLMN.

### CROSS REFERENCE TO RELATED APPLICATIONS

The present application is a continuation-application of International (PCT) Patent Application No. PCT/CN2021/104361, filed on Jul. 2, 2021, the entire contents of which are hereby incorporated by reference in its entirety.

### TECHNICAL FIELD

The present disclosure relates to the field of communication technologies, and in particular to a terminal device, a unified data management network element, and a first network element.

### BACKGROUND

With the continuous improvement of communication demand, a wireless communication network needs to cope with various emerging new application scenarios. In order to meet requirements of different services in various application scenarios, a concept of a slice has emerged. Different slices are customized and designed for the different services, and may also achieve dedicated and isolated network resources. While meeting the needs of different service scenarios, the different slices may also provide a better service.

When a terminal device accesses a Public Land Mobile Network (PLMN), identifier information of a requested slice in a registration request message may be carried. However, the PLMN accessed by the terminal device does not support the slice requested by the terminal device, resulting in the inability to meet a service requirement of the terminal device.

### SUMMARY OF THE DISCLOSURE

In a first aspect, a terminal device is provided by some embodiments of the present disclosure. The terminal device includes a processor and a memory. The memory is configured to store a computer program, and the processor is configured to call and run the computer program stored in the memory to perform: determining, by the terminal device, a first Public Land Mobile Network PLMN according to first slice information, and accessing the first PLMN.

In a second aspect, a unified data management network element is further provided by some embodiments of the present disclosure. The unified data management network element includes a processor and a memory. The memory is configured to store a computer program, and the processor is configured to call and run the computer program stored in the memory to perform: receiving, by the unified data management (UDM) network element, second slice information from a first network element in a third Public Land Mobile Network PLMN; and determining, by the UDM, second PLMN information according to the second slice information, and transmitting the second PLMN information to a terminal device, where the second PLMN information is used to determine a first PLMN by the terminal device, for accessing the first PLMN.

In a third aspect, a first network element is further provided by some embodiments of the present disclosure. the first network element includes a processor and a memory. The memory is configured to store a computer program, and the processor is configured to call and run the computer program stored in the memory to perform: transmitting, by the first network element in a third Public Land Mobile Network PLMN, second slice information to a unified data management network element UDM. The second slice information is used by the UDM to determine second PLMN information and transmit the second PLMN information to a terminal device, and the second PLMN information is used to determine a first PLMN by the terminal device, for accessing the first PLMN.

### BRIEF DESCRIPTION OF THE DRAWINGS

FIG. 1 is a schematic diagram of a communication system architecture according to some embodiments of the present disclosure.

FIG. 2 is a schematic flowchart of an access method according to some embodiments of the present disclosure.

FIG. 3 is an interactive schematic diagram of the access method according to a first example of the present application embodiment.

FIG. 4 is another interaction schematic diagram of the access method according to the first example of the present disclosure.

FIG. 5 is a schematic flowchart of the access method according to some embodiments of the present disclosure.

FIG. 6 is a schematic flowchart of the access method according to some embodiments of the present disclosure.

FIG. 7 is an interactive schematic diagram of the access method according to a second example of the present disclosure.

FIG. 8 is an interactive schematic diagram of the access method according to a third example of the present disclosure.

FIG. 9 is another interaction schematic diagram of the access method according to the third example of the present disclosure.

FIG. 10 is a schematic block diagram of a terminal device according to some embodiments of the present disclosure.

FIG. 11 is a schematic block diagram of the terminal device according to some embodiments of the present disclosure.

FIG. 12 is a schematic block diagram of the terminal device according to some embodiments of the present disclosure.

FIG. 13 is a schematic block diagram of a unified data management network element according to some embodiments of the present disclosure.

FIG. 14 is a schematic block diagram of a first network element according to some embodiments of the present disclosure.

FIG. 15 is a schematic block diagram of a communication device according to some embodiments of the present disclosure.

FIG. 16 is a schematic structure diagram of a chip according to some embodiments of the present disclosure.

FIG. 17 is a schematic block diagram of a communication system according to some embodiments of the present disclosure.

### DETAILED DESCRIPTION

The technical solutions in the embodiments of the present disclosure will be described below in conjunction with the accompanying drawings in the embodiments of the present disclosure.

The technical solutions in the embodiments of the present disclosure may be applied to various communication systems, for example: a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a Non-Terrestrial Networks (NTN) system, a universal mobile telecommunication system (UMTS), a wireless local area networks (WLAN), a wireless fidelity (Wi-Fi), a fifth generation communication (5th-generation, 5G) system, or other communication systems, etc.

Generally, traditional communication systems support a limited number of connections and are easy to implement. However, with a development of the communication technologies, mobile telecommunication systems will not only support traditional communications, but also, for example, a device to device (D2D) communication, a machine to machine (M2M) communication, a machine type communication (MTC), a vehicle to vehicle (V2V) communication, or vehicle to everything (V2X) communication for vehicular networks etc., and the embodiments of the present disclosure may also be applied to these communication systems.

In some embodiments, the communication system in the embodiment of the present disclosure can be applied to a carrier aggregation (CA) scenario, a dual connectivity (DC) scenario, or a standalone (SA) network-deployment scenario.

The communication system may include a terminal device, an access network device in a public land mobile network (PLMN), and various network entities. In some embodiments, the terminal device usually may also be called a user device (UE), an access terminal, a subscriber unit, a subscriber station, a mobile station, a mobile port, a remote station, a remote terminal, a mobile device, a user terminal, a terminal, a wireless communication device, a user agent, or a user apparatus, etc.

The terminal device can be a station (ST) in a WLAN. The terminal device can be a cellular phone, a cordless phone, a session initiation protocol (SIP) phone, a wireless local loop (WLL) station, a personal digital assistant (PDA) device, a handheld device with wireless communication capabilities, a computing device or other processing devices connected to wireless modems, an in-vehicle device, a wearable device, and a next-generation communication system. The next-generation communication system is for example a terminal device in an NR network or a terminal device in a future evolved public land mobile network (PLMN), and the like.

In some embodiments of the present disclosure, the terminal device can be deployed on land, whether being indoor or outdoor, handheld, wearable or vehicle-mounted. The terminal device can also be deployed on water (such as in ships, etc.). The terminal device can also be deployed in the air (such as in an aircraft, a balloon, and in a satellite, etc.).

In the embodiments of the present disclosure, the terminal device be a mobile phone, a Pad, a computer with a wireless transceiver function, a virtual reality (VR) terminal device, an augmented reality (AR) terminal device, a wireless terminal for industrial control, a wireless terminal device for self driving, a wireless terminal device for remote medical, a wireless terminal device for smart grid, a wireless terminal device for transportation safety, a wireless terminal device for smart city, a wireless terminal device for smart home, etc.

As an example but not a limitation, in some embodiments of the present disclosure, the terminal device may be a wearable device. The wearable device may also be referred to as a wearable smart device, which is a general term for devices that are wearable and developed from intelligent design of daily wearable articles through wearable techniques. The wearable devices are for example glasses, gloves, watches, clothing, shoes etc. A wearable device is a portable device that is worn directly on the body or integrated into a user's clothing or accessories. The wearable device is more than a hardware device, but can also realize powerful functions through software support, data interaction, and cloud interaction. In a broad sense, the wearable smart device includes a full-featured and large-sized device, such as a smart watch or a smart glass, all or part of whose functions can be realized without relying on smart phones. The wearable smart device also includes a device focusing on a certain kind of application function and needing to cooperate with other devices like a smart phone, such as all kinds of smart bracelets, smart ornaments for physical sign monitoring.

In some embodiments of the present disclosure, a network element in the PLMN includes a network entity and an access network device. The network entity includes, for example, an access and mobility management function (AMF), a user plane function (UPF), etc.

The access network device may be a device configured to communicate with a mobile device. The access network device may be an access point (AP) in WLAN, a base transceiver station (BTS) in GSM or CDMA, a NodeB (NB) in WCDMA, or an evolutional NodeB (eNB or eNodeB) in LTE, or a relay station or an access point, or a vehicle-mounted device, a wearable device and a network device (gNB) in the NR network or a network device in the future evolved PLMN network, etc.

As an example rather than a limitation, in some embodiments of the present disclosure, the network device can have a mobile feature. For example, the network device can be a mobile device. In some embodiments, the network device can be a satellite, a balloon station. For example, the satellite can be a low earth orbit (LEO) satellite, a medium earth orbit (MEO) satellite, a geostationary earth orbit (GEO) satellite, a high elliptical orbit (HEO) satellite etc. In some embodiments, the network device can also be a base station located on the land or in the water.

In some embodiments of the present disclosure, the access network device may provide services for a cell, and the terminal device communicates with the access network device through transmission resources (for example, frequency domain resources, or spectrum resources) used by the cell. The cell may be a cell corresponding to a network device (such as a base station), and the cell may belong to a macro base station or a base station corresponding to a small cell. The small cell here may include: a metro cell, a micro cell, a Pico cell, a Femto cell, etc. These small cells have the characteristics of small coverage and low transmit power, and are suitable for providing high-rate data transmission service.

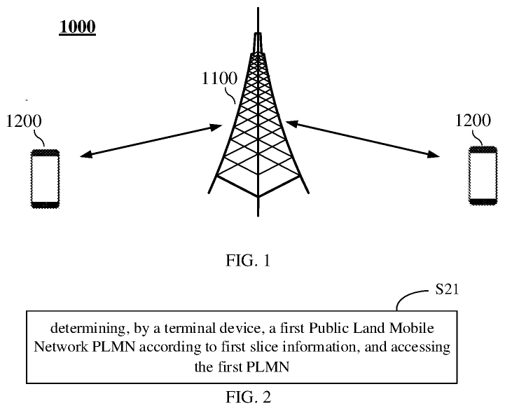

FIG. 1 illustrates a schematic diagram of a wireless communication system 1000. As shown in FIG. 1, the wireless communication system 1000 includes one access network device 1100 and two terminal devices 1200. In some embodiments, the wireless communication system 1000 may include a plurality of access network devices 1100, and other numbers of terminal devices 1200 may be included within the coverage region of each access network device 110, without limitation in the embodiments of the present disclosure. In some embodiments, as shown in FIG. 1, the wireless communication system 1000 may further include a mobility management entity (MME), the AMF, and other network entities, which is not limited herein.

It should be understood that a device with a communication function in the network/system in the embodiments of the present disclosure may be referred to as a communication device. Taking the communication system illustrated in FIG. 1 as an example, the communication device may include the network device and terminal device with communication functions, and the network device and terminal device may be specific devices as described above and will not be described herein. The communication device may further include other devices in the communication system, such as a network controller, a mobile management entity, and other network entities, which are not limited in the embodiments of the present disclosure.

It should be understood that the terms “system” and “network” may be used interchangeably in this document. The term “and/or” is only a description of an association relationship of associated objects, indicating that three relationships may exist, for example, A and/or B, which may indicate: the existence of A alone, the existence of both A and B, and the existence of B alone. In addition, the character “/” generally indicates that the front and rear associated objects are in an “or” relationship.

It should be understood that the “indication” mentioned in the embodiment of the present disclosure can be a direct indication, an indirect indication, or an association relationship. For example, A indicates B, which can indicate that A indicates B directly, for example, B can be obtained through A. It can also indicate that A indicates B indirectly, for example, A indicates C, and B can be obtained through C. It can also indicate that there is an association relationship between A and B.

In the description of the embodiments of the present disclosure, the term “correspondence” can indicate that there is a direct or indirect corresponding relationship between two, or there is an association relationship between the two, or there is a relationship between indication and being indicated, configuration and being configurated.

In order to understand the technical solutions in the embodiments of the present disclosure, the technical solutions of the present disclosure are detailed below through specific embodiments. The related technical contents of the embodiments of the present disclosure described below as optional solutions, can be arbitrarily combined with the technical solutions in the embodiments of the present disclosure, which belong to the scope of the embodiments of the present disclosure.

In a 5G system, a slice identifier may be single network slice selection assistance information (S-NSSAI). When the terminal device UE selects a PLMN for access, the UE is not aware of which S-NSSAIs are supported by the PLMN. In some embodiments, the access process includes the following.

The UE carries requested network slice selection assistance information (requested NSSAI) in a registration request message. The requested NSSAI may include a plurality of S-NSSAIs to represent a slice required for the request.

If the PLMN where the UE is located supports access of a certain S-NSSAI in the requested NSSAI, the AMF carries the S-NSSAI in allowed network slice selection auxiliary information (allowed NSSAI) in the registration acceptance message, so as to indicate that the UE is allowed to use a service of the slice. If the PLMN where the UE is located or a registration region where the UE is located does not support the access of a certain S-NSSAI in the requested NSSAI, the AMF carries the S-NSSAI in rejected network slice selection auxiliary information (rejected NSSAI) in the registration acceptance message, and carries a cause value for rejecting the S-NSSAI. A reject cause value includes “Current PLMN does not support the S-NSSAI”, “Current registration region does not support the S-NSSAI”, or the like.

If the cause value for rejecting the S-NSSAI is “Current PLMN does not support the S-NSSAI”, the S-NSSAI may be requested again only when the UE is moved to another PLMN. When the UE is moved to the another PLMN, the UE may delete a record where the S-NSSAI is rejected.

After in-depth research by an inventor of the present disclosure, it is found that in the above-mentioned related art, the UE does not rely on the slice information when the UE performs PLMN selection, resulting in the failure to ensure a service request required by the terminal device.

The solution provided by the embodiments of the present disclosure is mainly used to solve at least one of the above-mentioned problems.

In order to gain a more detailed understanding of the characteristics and technical solution of the embodiments of the present disclosure, the implementation of the embodiments of the present disclosure is described in detail below in conjunction with the accompanying drawings. The accompanying drawings are for reference only and are not intended to limit the embodiments of the present disclosure.

FIG. 2 is a schematic flowchart of an access method according to some embodiments of the present disclosure. In some embodiments, the method may be applied to the system shown in FIG. 1, but is not limited to this. The method includes at least some of the following.

At block S21, the terminal device determines a first PLMN according to first slice information, and accesses the first PLMN.

In some embodiments, the first slice information may include any information related to the slice, such as a slice requested by the terminal device, PLMN information corresponding to at least one slice, PLMN information determined based on other slice information, and so on.

For example, in some embodiments of the present disclosure, the first slice information may include PLMN information related to the slice requested by the terminal device, such as PLMN information related to a slice currently requested by the terminal device, or PLMN information related to a slice previously requested by the terminal device.

In some embodiments, the first PLMN may be a PLMN that supports at least one first target slice requested by the terminal device.

For example, the terminal device requests slices S-NSSAI and S-NSSAI B, and the first PLMN may be a PLMN that supports the S-NSSAI and the S-NSSAI B at the same time, or a PLMN that only supports the S-NSSAI A.

The above block of determining the first PLMN is a block of performing the PLMN selection. Since the terminal device performs the PLMN selection based on the slice information, it is helpful to select the PLMN that supports the slice requested by the terminal device, thereby meeting the service requirement of the terminal device.

An exemplary implementation of a plurality of first slice information may be provided by some embodiments of the present disclosure. For example, the first slice information may include PLMN information rejecting a certain slice, PLMN information allowing or supporting a certain slice, PLMN information that is determined based on slice information involved in a historical access process of the terminal device, and so on. Specific examples are as follows.

### A First Example

In the example, the first slice information includes the following.

N first target slices requested by the terminal device and N second PLMN information respectively corresponding to N first target slices. N is an integer greater than or equal to 1.

For example, the first target slice is a slice requested by the terminal device in a current PLMN selection process, i.e., in a process of determining the first PLMN. The N first target slices may be all or part of the slices requested by the terminal device.

For example, the slices requested by the terminal device include the S-NSSAI A, the S-NSSAI B and S-NSSAI C. The first slice information includes the second PLMN information corresponding to the S-NSSAI and the S-NSSAI B, respectively, but does not include the second PLMN information corresponding to the S-NSSAI C. The terminal device may determine the first PLMN according to the second PLMN information corresponding to the S-NSSAI and the S-NSSAI B.

In some embodiments, i-th second PLMN information in the N second PLMN information is configured to indicate at least one second PLMN rejecting a corresponding slice thereof, and i is a positive integer less than or equal to N.

That is to say, the first slice information includes N second PLMN information. The i-th second PLMN information or each second PLMN information may be configured to indicate at least one second PLMN, and the second PLMN is a PLMN rejecting a corresponding slice.

In some embodiments, the above-mentioned first slice information including the N second PLMN information may also be referred to as a list of rejected/forbidden PLMN. The first slice information may include the second PLMN information corresponding to the N first target slices, as well as the second PLMN information corresponding to other slices.

In some embodiments, the list of rejected/forbidden PLMN may be shown in Table 1.

TABLE 1

| Number | Slice | Second PLMN |
|---|---|---|
| 1 | S-NSSAI A | PLMN1, PLMN2 |
| . . . | | |
| K | S-NSSAI B | PLMN3 |

In some embodiments, there is N second PLMN information related to a slice currently requested by the terminal device, and thus K≥N.

Based on this, the terminal device may extract relevant second PLMN information from the first slice information according to the requested N first target slices, and select the PLM according to the extracted second PLMN information.

In some embodiments, the terminal device may obtain the first slice information based on the slice information rejected by each PLMN, such as a third PLMN. In some embodiments, the method of some embodiments of the present disclosure further includes the following.

The terminal device determines and/or updates the first slice information according to the second slice information. In some embodiments, the second slice information is configured to indicate at least one slice rejected by the third PLMN.

In some embodiments of the present disclosure, the second slice information is configured to determine and/or update the first slice information, such as slice information involved in a historical registration request. The third PLMN may be a PLMN accessed by the terminal device or a PLMN received a broadcast message.

In some embodiments, the terminal device may update at least one second PLMN information in the first slice information according to the at least one slice rejected by the third PLMN.

In some embodiments, a certain slice rejected by the third PLMN exists in Table 1, an identifier of the third PLMN may be added to the second PLMN information corresponding to the certain slice. In some embodiments, another slice rejected by the third PLMN does not exist in Table 1, a row corresponding to the another slice may be added in Table 1, and an identifier of the third PLMN may be recorded as the second PLMN information corresponding to the another slice in the row.

In some embodiments, the third PLMN may also be one of PLMNs indicated by the N second PLMN information.

In some embodiments, the terminal device may obtain the second slice information configured to indicate the slice rejected by the third PLMN from a registration feedback message obtained when the third PLMN is accessed, such as a registration acceptance message or a registration rejection message.

In some embodiments, the method of some embodiments of the present disclosure further includes the following.

The terminal device transmits a first registration request to a first network element in the third PLMN.

In a case that the first registration acceptance message transmitted by the first network element is received, the terminal device obtains the second slice information in the first registration acceptance message.

In some embodiments, the first network element may include an AMF in the third PLMN. As explained above, the registration request transmitted by the terminal device may include slice information requested by the terminal device (Requested NSSAI). The AMF may carry slice information rejected by the current PLMN in the registration acceptance message (rejected NSSAI), i.e., the second slice information.

In some embodiments, the method of some embodiments of the present disclosure further includes the following.

The terminal device transmits a first registration request to a first network element in the third PLMN.

In a case that the first registration rejection message transmitted by the first network element is received, the terminal device obtains the second slice information in the first registration rejection message.

In some embodiments, the first network element may include an AMF in the third PLMN. The AMF rejects an access request of the terminal device and carries the second slice information in the registration rejection message, so as to indicate the slice information rejected by the third PLMN, i.e., the second slice information.

It can be seen that, the terminal device may maintain the first slice information as shown in the example in Table 1 via the slice information rejected by each PLMN and obtained in the historical access process, such that the terminal device may perform the PLMN selection based on the first slice information in a next access process. In some embodiments, the terminal device may perform the PLMN selection according to the currently requested slice (herein after will be referred to as the first target slice) and the first slice information. That is, the block S21, i.e., the determining, by the terminal device, the first PLMN according to the first slice information, includes the following operation.

The terminal device determines the first PLMN according to the requested N first target slices and the first slice information.

In some embodiments, the determining, by the terminal device, the first PLMN according to the requested N first target slices and the first slice information, includes the following operation.

The terminal device determines the N second PLMN information corresponding to the N first target slices in the first slice information.

The terminal device determines the first PLMN based on the N second PLMN information.

In some embodiments, the determining, by the terminal device, the first PLMN based on the N second PLMN information, includes the following operation.

The terminal device determines the first PLMN in at least one candidate PLMN of other candidate PLMN except for the PLMN indicated by the N second PLMN information.

In some embodiments, the first slice information includes the list of rejected/forbidden PLMN shown in Table 1. The terminal device requests a plurality of first target slices, and the plurality of first target slices may include S-NSSAI and S-NSSAI D. The second PLMN information corresponding to one of the first target slices, i.e., the S-NSSAI A, is included in Table 1. Therefore, the terminal device may determine that the second PLMN information corresponding to the S-NSSAI A includes PLMN1 and PLMN2. Therefore, the terminal device may exclude the PLMN1 and the PLMN2 from candidate PLMNs, and then select the first PLMN from remaining PLMNs.

In some embodiments, the terminal device requests a plurality of first target slices, and the plurality of first target slices may include S-NSSAI and S-NSSAI B. If the second PLMN information corresponding to the S-NSSAI A includes PLMN 1, and the second PLMN information corresponding to the S-NSSAI B includes PLMN 2, the terminal device may exclude the PLMN1 and the PLMN2 from candidate PLMNs, and then select the first PLMN from remaining PLMNs.

In some embodiments, the determining, by the terminal device, the first PLMN based on the N second PLMN information, further includes the following.

If there is no candidate PLMN in the at least one candidate PLMN different from the PLMN indicated by the N second PLMN information, the terminal device determines the first PLMN in the at least one candidate PLMN according to a priority of each first target slice in the N first target slices.

In some embodiments, the terminal device requests a plurality of first target slices, and the plurality of first target slices may include S-NSSAI and S-NSSAI B. If the second PLMN information corresponding to the S-NSSAI A includes PLMN 1, and the second PLMN information corresponding to the S-NSSAI B includes PLMN 2, the terminal device may exclude the PLMN1 and the PLMN2 from the candidate PLMNs. If there is no remaining PLMN, the PLMN1 or the PLMN2 may be selected to serve the terminal device according to a priority of the S-NSSAI and a priority of the S-NSSAI B. In some embodiments, if the priority of the S-NSSAI A is high, or the priority of the S-NSSAI B is low, the PLMN2 corresponding to the S-NSSAI B may be selected to serve the terminal device.

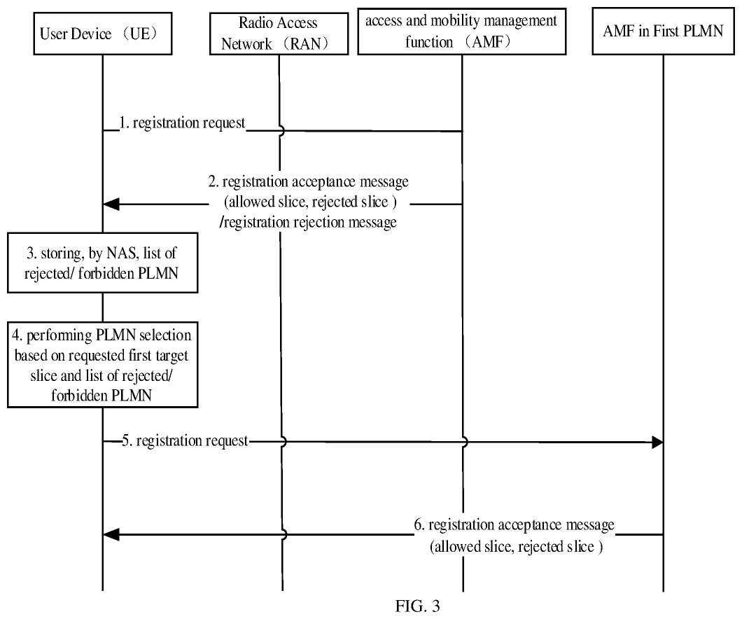

The access method in the above-mentioned example may be implemented by referring to the interaction schematic diagram shown in FIG. 3. As shown in FIG. 3, the access method may include following operations.

Step 1: the UE initiates a registration request to the AMF in the third PLMN, the registration request carries a requested slice identifier (Requested NSSAI), and the Requested NSSAI is configured to indicate a slice that the terminal device wants/desires to access. In some embodiments, the requested NSSAI may include one or more S-NSSAIs.

Step 2: the AMF carries an allowed slice identifier (allowed NSSAI, which is configured to represent an allowed slice) and a rejected slice identifier (rejected NSSAI, which is configured to represent a rejected slice) in the registration acceptance message. The rejected NSSAI includes one or more rejected S-NSSAIs, and each of the one or more rejected S-NSSAIs has a corresponding reject cause value. The reject cause value includes “Current PLMN does not support the S-NSSAI”, “Current registration region does not support the S-NSSAI”. The AMF may also return a new 5G Globally Unique Temporary UE Identity (5G GUTI) to the UE.

Step 3: Non Access Stratum (NAS) of the terminal device reserves the PLMN information (PLMN list) corresponding to the rejected S-NSSAI, so as to update the list of rejected/forbidden PLMN.

Step 4: when the UE initiates the service again, the NAS may select the PLMN based on the S-NSSAI information required by the UE and a list in the Step 3, and determine the first PLMN.

Step 5, the UE initiates a registration request message again under the first PLMN.

Step 6, the AMF in the first PLMN carries the allowed NSSAI and the rejected NSSAI in the registration acceptance message, which is consistent with the Step 2.

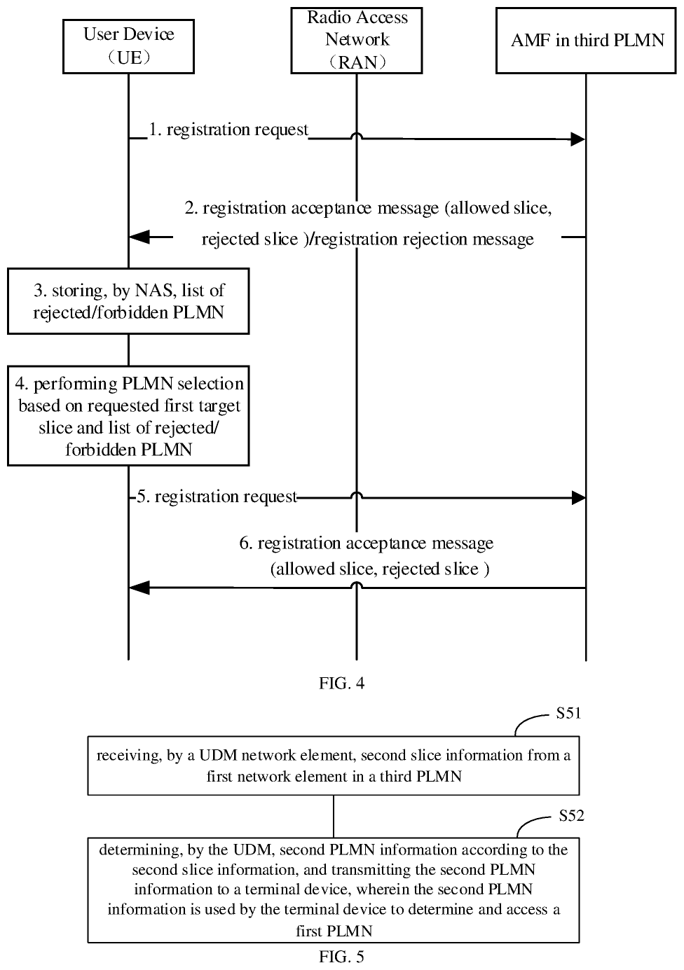

In a practical application, the first PLMN selected in the above-mentioned Step 5 may be the third PLMN. Therefore, the above-mentioned steps may also refer to an interaction schematic diagram of an example as shown in FIG. 4.

It can be seen that, according to the above-mentioned example, the terminal device determines and/or updates the first slice information according to the slice information rejected by the PLMN, such that the terminal device may perform the PLMN selection based on the first slice information in the next access process. It is helpful to select the PLMN that supports the slice requested by the terminal device, thereby meeting the service requirement of the terminal device.

### A Second Example

In the example, first slice information includes the following.

Second PLMN information is received by the terminal device.

In some embodiments, the second PLMN information is configured to indicate at least one second PLMN determined based on second slice information.

In some embodiments, the second PLMN information may be determined by other network elements based on the second slice information. In some embodiments, it is determined by a network element that interacts with the terminal device in a historical access process. In some embodiments, the above-mentioned method may further include the following.

The terminal device transmits a first registration request to a first network element in a third PLMN. The first registration request is configured to indicate the terminal device to request a second target slice. The second target slice is configured to determine the second slice information.

In a case that the first registration acceptance message transmitted by the first network element is received, second PLMN information in the first registration acceptance message may be obtained.

In some embodiments, the above-mentioned first network element may include an AMF in the third PLMN.

In some embodiments, the second PLMN information may be a preferred PLMN list configured for the terminal device. The list includes identifiers of a plurality of second PLMNs. The second PLMN may also be called a preferred/priority PLMN.

In some embodiments, the above-mentioned second slice information configured to determine the second PLMN information may include an identifier of a slice requested for access in the historical access process, such as an identifier of the above-mentioned second target slice, as well as a slice allowed in the historical access process and a slice rejected in the historical access process, such as a slice allowed by the third PLMN and a slice rejected by the third PLMN.

In some embodiments, a process of determining the second PLMN information may be implemented by a unified data management UDM network element based on slice information is sensed by the UDM.

In some embodiments, the second slice information is configured to indicate at least one of the second target slice, the slice allowed by the third PLMN, and the slice rejected by the third PLMN. The first registration request is configured to cause the first network element to transmit the second slice information to the UDM, so as to obtain the second PLMN information determined by the UDM based on the second slice information.

In some embodiments, the determining, by the terminal device, the first PLMN based on the first slice information, may include the following.

The terminal device determines the first PLMN in the at least one second PLMN.

In some embodiments, the terminal device may determine the first PLMN according to a priority in the preferred PLMN list. For example, a PLMN with a highest priority may be determined as the first PLMN.

In some embodiments, the terminal device may take a PLMN indicated by the at least one second PLMN information in the example as at least one candidate PLMN, that is, the preferred PLMN in the above-mentioned 1 preferred PLMN list may be taken as the at least one candidate PLMN by the terminal device. Then, by using a method of the first example, a PLMN that rejects the first target slice may be determined according to the requested first target slice, and the first PLMN may be determined in at least one candidate PLMN of other candidate PLMN except for the PLMN that rejects the first target slice.

From a perspective of the UDM, as shown in FIG. 5, the access method may include a following operation.

At block S51, the UDM receives the second slice information from the first network element in the third PLMN.

At block S52, the UDM determines the second PLMN information according to the second slice information, and transmits the second PLMN information to the terminal device. The second PLMN information is used to determine a first PLMN by the terminal device, for accessing the first PLMN.

In some embodiments, the second slice information is configured to indicate at least one of a second target slice requested by the terminal device, a slice allowed by the third PLMN, and a slice rejected by the third PLMN.

In some embodiments, the above-mentioned second PLMN information may be carried by steering of Roaming information (steering of Roaming IE) transmitted by UDM.

In some embodiments, at the above-mentioned block S52, the transmitting the second PLMN information to the terminal device, may include the following.

The steering of Roaming IE is transmitted to the first network element in the third PLMN, such that the first network element carries the steering of Roaming IE in a registration acceptance message and transmits the registration acceptance message to the terminal device.

In some embodiments, the first network element may be the AMF.

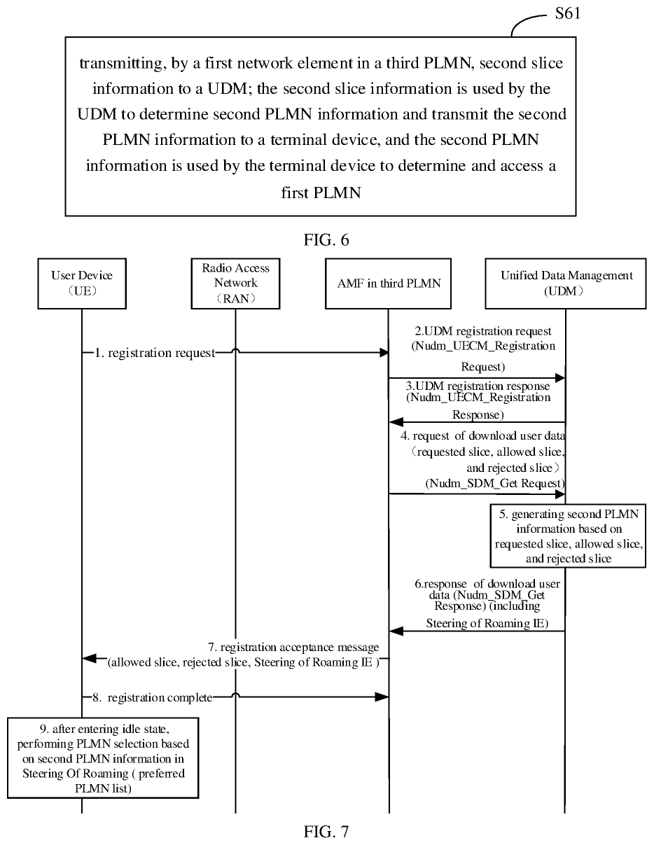

From a perspective of the first network element, as shown in FIG. 6, the access method may include a following operation.

At block S61, the first network element in the third PLMN transmits the second slice information to the UDM. The second slice information is used by the UDM to determine the second PLMN information and transmit the second PLMN information to the terminal device. The second PLMN information is used to determine a first PLMN by the terminal device, for accessing the first PLMN.

In some embodiments, the second slice information is configured to indicate at least one of a second target slice requested by the terminal device, the slice allowed by the third PLMN, and the slice rejected by the third PLMN.

In some embodiments, the first network element is the AMF.

The access method in the above-mentioned example may be implemented with reference to an interaction schematic diagram shown in FIG. 7. As shown in FIG. 7, the access method may include following operations.

Step 1: the UE initiates a registration request to the AMF in the third PLMN and carries the Requested NSSAI, and the Requested NSSAI is configured to indicate a slice that the terminal device wants to access.

Step 2: the AMF transmits a UDM registration request message, such as a Nudm_UECM_Registration request message, to the UDM, and the UDM registration request message carries an identifier (ID) of the AMF.

Step 3: the UDM returns a UDM registration response message, such as Nudm_UECM_Registration response message, to the AMF.

Step 4: the AMF transmits a request message for downloading user data to the UDM, such as Nudm_SDM_Get Request information, and the request message for downloading user data carries the requested slice (Requested NSSAI), the allowed slice (allowed NSSAI), and the rejected slice (Rejected NSSAI); the UDM maintains a list of PLMNs corresponding to rejected S-NSSAI, and is configured to determine the list of rejected/prohibited PLMNs for the rejected S-NSSAI. The list of rejected/forbidden PLMN of S-NSSAI may also be used as a reference for other UEs.

Step 5: the UDM generates the second PLMN information according to the Requested NSSAI, the Allowed NSSAI and the Rejected NSSAI, that is, a PLMN list is suitable for the terminal device (i.e., preferred PLMN list).

Step 6: the UDM carries the preferred PLMN list in the Steering of Roaming IE and transmits the Steering of Roaming IE to the AMF.

Step 7: the AMF transmits a registration acceptance message to the UE. The registration acceptance message includes the allowed NSSAI, the rejected NSSAI, the steering of Roaming IE, and further includes newly allocated 5G-GUTI.

Step 8: the UE returns a registration completion message to the AMF.

Step 9: after the UE enters an idle state, the UE selects PLMN based on the second PLMN information in the Steering Of Roaming, i.e., the preferred PLMN list.

After the PLMN selection is completed, the UE initiates the registration request message again under the selected PLMN, which is consistent with the Step 1.

It can be seen that, according to the above-mentioned example, a network side generates preferred PLMN information for the terminal device according to the slice information related to the terminal device. The terminal device performs the PLMN selection based on the preferred PLMN information in the next access process. It is helpful to select the PLMN that supports the slice requested by the terminal device, thereby meeting the service requirement of the terminal device.

### A Third Example

In the example, first slice information includes the following.

N first target slices requested by the terminal device and N second PLMN information respectively corresponding to N first target slices. N is an integer greater than or equal to 1.

A difference between the third example and the first example is that j-th second PLMN information in the N second PLMN information is configured to indicate at least one second PLMN that supports or allows a corresponding slice thereof, and j is a positive integer less than or equal to N.

That is to say, the first slice information includes N second PLMN information. The j-th second PLMN information or each second PLMN information may be configured to indicate at least one second PLMN, and the second PLMN is the PLMN supporting a corresponding slice.

In some embodiments, the above-mentioned first slice information including the N second PLMN information may be represented in a list, as shown in Table 2, where M≥N.

TABLE 2

| Number | Slice | Second PLMN |
|---|---|---|
| 1 | S-NSSAI C | PLMN4 |
| . . . | | |
| M | S-NSSAI D | PLMN3, PLMN5 |

In some embodiments, the second PLMN information may be determined based on slice information transmitted by other network elements, such as slice information supported by other network elements.

In some embodiments, the above-mentioned method further includes the following.

The terminal device determines and/or updates the first slice information according to the received second slice information transmitted by a second network element in the third PLMN.

The second slice information is configured to indicate at least one slice allowed by the third PLMN.

In some embodiments, the second network element may include the AMF in the third PLMN. The second slice information may be carried by the registration acceptance message transmitted by the AMF to the terminal device.

In some embodiments, the second network element may include an access network device. The second slice information is carried by at least one of following information.

A broadcast message of the access network device.

A Radio Resource Control (RRC) release message.

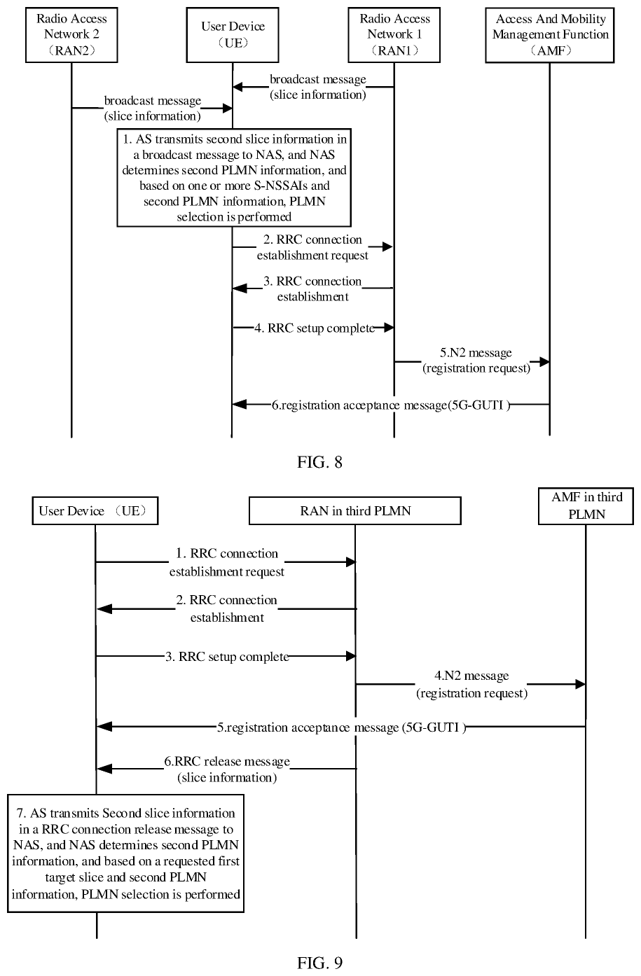

FIG. 8 is an interactive schematic diagram of an access network device (radio access network) carrying the second slice information in the broadcast message. As shown in FIG. 8, the access method includes following operations.

Step 0: each radio access network, such as a radio access network 1 (RAN1) and a radio access network 2 (RAN2), broadcasts supported slice information in the broadcast message, i.e., the second slice information, such as one or more S-NSSAIs.

Step 1: Access Stratum (AS) of the UE transmits the second slice information in the broadcast message to Non Access Stratum (NAS), and the NAS determines the second PLMN information corresponding to each slice, i.e., the PLMN information supporting the slice. Based on the S-NSSAI information requested by the UE and the second PLMN information, the PLMN selection is performed, for example, the first PLMN corresponding to RAN1 is selected.

Step 2: the NAS of the UE requests the AS to establish an RRC connection and provides the required slice information, a cause value of establishing the RRC connection, and NAS-PDU. Here, the NAS-PDU refers to the registration request message, and the registration request message carries a parameter such as 5G-GUTI and a registration type.

The UE transmits the RRC connection establishment request, such as an RRC setup request message, to the RAN1, and the RRC setup request message carries the 5G serving Temporary Mobile Station Identity (S-TMSI) and a cause value establishing RRC.

Step 3: the RAN1 accepts the RRC establishment request and transmits an RRC connection establishment message, such as the RRC setup message, to the UE.

Step 4: the UE transmits an RRC connection establishment completion message, such as an RRC setup complete message, to RAN, and the NAS-PDU in the step 2 and the slice information in the step 2 are carried in the RRC connection establishment completion message.

Step 5: the RAN1 selects the AMF and transmits an N2 message, i.e., UL NAS TRANSPORT message, to the AMF, and the NAS-PDU is carried in the N2 message.

Step 6: the AMF accepts registration and returns a registration acceptance message to the UE, and new 5G-GUTI is carried in the registration acceptance message.

FIG. 9 is another interaction schematic diagram of an access network device (radio access network) carrying the second slice information in a broadcast message. As shown in FIG. 9, the access method includes following operations.

Step 1: the NAS of the UE requests the AS to establish an RRC connection and provides the required slice information, a cause value of establishing the RRC connection, and NAS-PDU. Here, the NAS-PDU refers to the registration request message, and the registration request message carries a parameter such as 5G-GUTI and a registration type.

The UE transmits an RRC connection establishment request, such as an RRC setup request message, to the RAN in the third PLMN, and the RRC setup request message carries S-TMSI and a cause value of establishing RRC.

Step 2: the RAN accepts the RRC establishment request and transmits an RRC connection establishment message, such as the RRC setup message, to the UE.

Step 3: the UE transmits an RRC connection establishment completion message, such as an RRC setup complete message, to the RAN, and the NAS-PDU in the step 2 and the slice information in the step 2 are carried in the RRC connection establishment completion message.

Step 4: the RAN selects the AMF and transmits an N2 message, i.e., UL NAS TRANSPORT message, to the AMF, and the NAS-PDU is carried in the N2 message.

Step 5: the AMF accepts registration and returns a registration acceptance message to the UE, and new 5G-GUTI is carried in the registration acceptance message.

Step 6: the RAN transmits an RRC release message, such as an RRC release message, to the UE. The RRC release message carries slice information. The slice message is configured to indicate the slice supported by the third PLMN. The slice message is a second slice message.

Step 7: the AS of the UE transmits the second slice information in the RRC release message to the NAS. Based on the second slice information, the NAS may obtain the PLMN information corresponding to a supporting slice, i.e., the second PLMN information. The PLMN is selected based on the S-NSSAI information requested by the UE and the second PLMN information. If a selected PLMN is inconsistent with a currently used PLMN, the UE will initiate a registration request message again under the selected PLMN, which is consistent with the Step 1.

It can be seen that according to the above-mentioned example, the terminal device determines the PLMN information supporting a slice based on the slice information transmitted by the network side. The terminal device performs the PLMN selection based on the PLMN information supporting the slice in the next access process. It is helpful to select the PLMN that supports the slice requested by the terminal device, thereby meeting the service requirement of the terminal device.

The specific settings and implementation methods of some embodiments of the present disclosure have been described from different perspectives through a plurality of embodiments. With the above-mentioned at least one embodiment, the terminal device performs the PLMN selection based on the slice information, and thus it is helpful to select the PLMN that supports the slice requested by the terminal device, thereby meeting the service requirement of the terminal device.

Corresponding to a processing method of the above-mentioned at least one embodiment, a terminal device 100 may be further provided by some embodiments of the present disclosure, as shown in FIG. 10. The terminal device 100 may include the following.

A first processing module 110 is configured to determine a first PLMN based on first slice information and access the first PLMN.

In some embodiments, the first slice information includes the following.

N second PLMN information respectively corresponds to N first target slices requested by the terminal device, and N is an integer greater than or equal to 1.

In some embodiments, i-th second PLMN information in the N second PLMN information is configured to indicate at least one second PLMN rejecting a corresponding slice thereof, and i is a positive integer less than or equal to N.

In some embodiments, the first processing module 110 is further configured to perform the following.

The first processing module 110 is further configured to determine and/or update the first slice information according to the second slice information. In some embodiments, the second slice information is configured to indicate at least one slice rejected by a third PLMN.

In some embodiments, as shown in FIG. 11, the terminal device 100 further includes the following.

A first communication module 120 is configured to transmit a first registration request to a first network element in the third PLMN.

In some embodiments, the first processing module 110 is further configured to obtain second slice information in a first registration acceptance message in a case that the first registration acceptance message transmitted by the first network element is received.

In some embodiments, the first processing module 110 is further configured to obtain second slice information in a first registration rejection message in a case that the first registration rejection message transmitted by the first network element is received.

In some embodiments, the first processing module 110 is configured to perform the following.

The first processing module 110 is configured to determine the first PLMN according to the N first target slices and the first slice information.

In some embodiments, the first processing module 110 is configured to perform the following.

The first processing module 110 is configured to determine N second PLMN information corresponding to the N first target slices in the first slice information.

The first processing module 110 is configured to determine the first PLMN based on the N second PLMN information.

In some embodiments, the first processing module 110 is configured to perform the following.

The first processing module 110 is configured to determine the first PLMN in at least one candidate PLMN of other candidate PLMN except for the PLMN indicated by the N second PLMN information.

In some embodiments, the first processing module is configured to perform the following.

In case that there is no candidate PLMN in the at least one candidate PLMN different from the PLMN indicated by the N second PLMN information, the terminal device is configured to determine the first PLMN in at least one candidate PLMN according to the priority of each first target slice in the N first target slices.

In some embodiments, the first slice information includes the following.

Second PLMN information is received by the terminal device.

In some embodiments, the second PLMN information is configured to indicate at least one second PLMN determined based on second slice information.

In some embodiments, as shown in FIG. 12, the terminal device further includes the following.

A second communication module 130 is configured to transmit a first registration request to the first network element in the third PLMN. The first registration request is configured to indicate the terminal device to request a second target slice. The second target slice is configured to determine the second slice information.

In some embodiments, the first processing module 110 is further configured to obtain the second PLMN information in the first registration acceptance message in a case that the first registration acceptance message transmitted by the first network element is received.

In some embodiments, the second slice information is configured to indicate at least one of the second target slice, a slice allowed by the third PLMN, and a slice rejected by the third PLMN.

The first registration request is configured to cause the first network element to transmit the second slice information to a UDM network element, such that the second PLMN information determined by the UDM based on the second slice information is obtained.

In some embodiments, the first processing module 110 is configured to perform the following.

The first processing module 110 is configured to determine the first PLMN in at least one second PLMN.

In some embodiments, j-th second PLMN information in the N second PLMN information is configured to indicate at least one second PLMN supporting a corresponding slice thereof, and j is a positive integer less than or equal to N.

In some embodiments, the first processing module 110 is further configured to perform the following.

The first processing module 110 is further configured to determine and/or update the first slice information according to the received second slice information transmitted by a second network element in the third PLMN.

In some embodiment, the second slice information is configured to indicate at least one slice supported by the third PLMN.

In some embodiments, the second network element includes an access network device, and the second slice information is carried by at least one of the following information.

A broadcast message of the access network device.

A radio resource control (RRC) release message.

In some embodiments, the first processing module 110 is configured to perform the following.

The first processing module 110 is configured to determine the first PLMN in a PLMN indicated by the N second PLMN information.

In some embodiments, the first processing module is configured to perform the following.

The first processing module is configured to determine the first PLMN in the PLMN indicated by the N second PLMN information according to a priority of each first target slice in the N first target slices.

The terminal device 100 of some embodiments of the present disclosure may implement a corresponding function of the terminal device in the above-mentioned method embodiment. For a corresponding process, a corresponding function, a corresponding implementation method, and a corresponding technical effect of each module (a submodule, unit or component, etc.) of the terminal device 100, reference may be made to the above description in the above-mentioned method embodiment, which will not be repeated here.

It should be noted that a function described by each module (a submodule, unit or component, etc.) of the terminal device 100 of some embodiments of the present disclosure may be implemented by different modules (a sub module, unit or component, etc.) or by the same module (sub module, unit, or component, etc.). For example, a first transmission module and a second transmission module may be different modules or the same module, both of which may implement a corresponding function of the terminal device in some embodiments of the present disclosure.

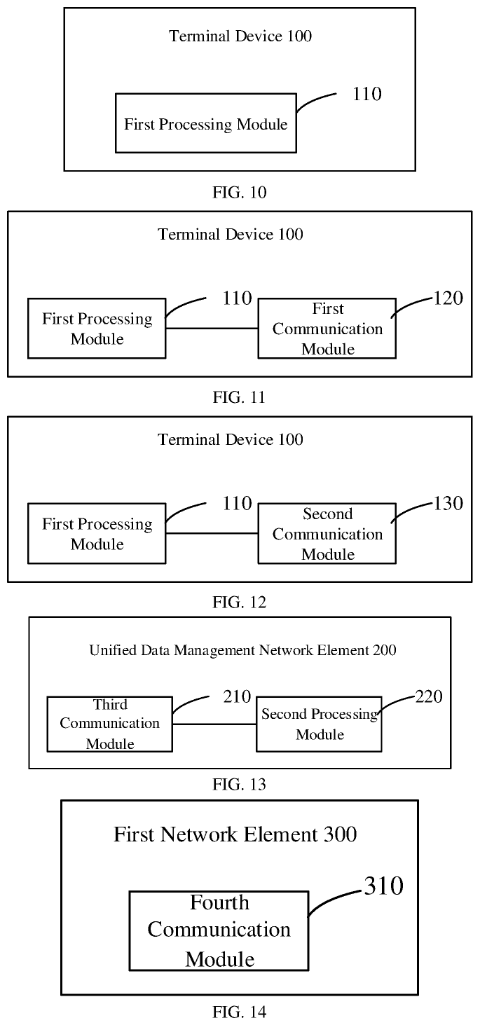

A unified data management (UDM) network element 200 may be provided by some embodiments of the present disclosure, as shown in FIG. 13. The UDM network element 200 includes the following.

A third communication module 210 is configured to receive second slice information from a first network element in a third PLMN.

A second processing module 220 is configured to determine second PLMN information according to the second slice information.

In some embodiments, the third communication module 210 is further configured to transmit the second PLMN information to the terminal device. The second PLMN information is used to determine a first PLMN by the terminal device, for accessing the first PLMN.

In some embodiments, the second slice information is configured to indicate at least one of a second target slice requested by the terminal device, a slice allowed by the third PLMN, and a slice rejected by the third PLMN.

In some embodiments, the second PLMN information is carried by steering of Roaming IE transmitted by the UDM.

In some embodiments, the third communication module 210 is configured to perform the following.

The third communication module 210 is configured to transmit the steering of Roaming IE to the first network element, such that the first network element carries the steering of Roaming IE in a registration acceptance message and transmits the registration acceptance message to the terminal device.

The UDM 200 provided by some embodiments of the present disclosure may implement a corresponding function of the UDM in the above-mentioned method embodiment. For a corresponding process, a corresponding function, a corresponding implementation method, and a corresponding technical effect of each module (a sub module, unit or component, etc.) of the UDM 200, reference may be made to the above description in the above-mentioned method embodiment, which will not be repeated here.

A first network element 300 may be further provided by some embodiments of the present disclosure. The first network element 300 is arranged on the third PLMN, as shown in FIG. 14. The first network element 300 includes the following.

A fourth communication module 310 is configured to transmit second slice information to the UDM network element. The second slice information is used by the UDM to determine second PLMN information and transmit the second PLMN information to the terminal device, and the second PLMN information is used to determine a first PLMN by the terminal device, for accessing the first PLMN.

In some embodiments, the second slice information is configured to indicate at least one of a second target slice requested by the terminal device, a slice allowed by the third PLMN, and a slice rejected by the third PLMN.

In some embodiments, the first network element 300 is an AMF.

The first network element 300 of some embodiments of the present disclosure may implement a corresponding function of the first network element in the above-mentioned method embodiment. For a corresponding process, a corresponding function, a corresponding implementation method, and a corresponding technical effect of each module (a sub module, unit or component, etc.) of the first network element 300, reference may be made to the above description in the above-mentioned method embodiment, which will not be repeated here.

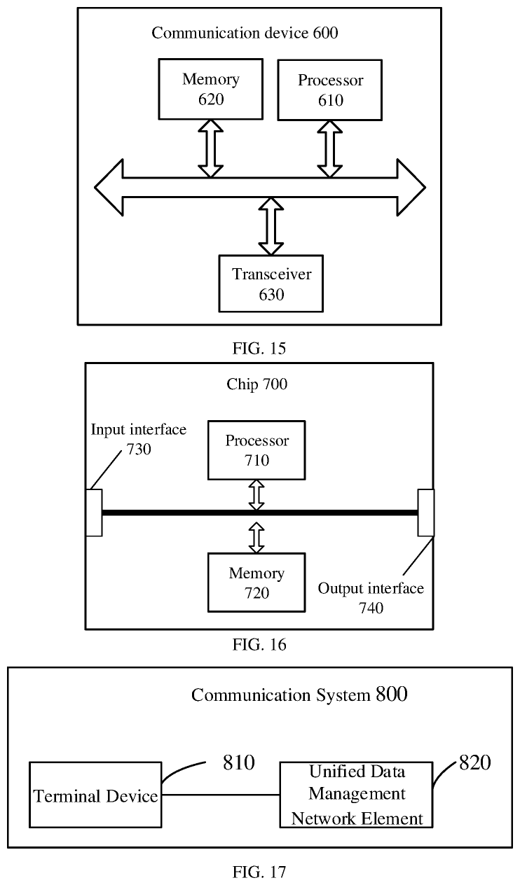

FIG. 15 is a schematic block diagram of a communication device 600 according to some embodiments of the present disclosure. The communication device 600 includes a processor 610. The processor 610 may be configured to call and run the computer program stored in a memory to perform the method in some embodiments of the present disclosure.

The communication device 600 includes a memory 620. The processor 610 may be configured to call and run the computer program stored in the memory 620 to perform the method in some embodiments of the present disclosure.

The memory 620 may be a separate device from the processor 810 or may be integrated into the processor 610.

In some embodiments, the communication device 600 may further include a transceiver 630. The processor 610 may control the transceiver to communicate with other devices, specifically, to send information or data to, or receive information or data from, the other devices.

In some embodiments, the transceiver 630 may include a transmitter and a receiver. The transceiver 630 may also further includes an antenna, and the number of antennas may be one or more.

In some embodiments, the communication device 600 may be the UDM of some embodiments of the present disclosure, and the communication device 600 may implement a corresponding process implemented by the UDM in the various methods of the embodiments of the present disclosure, which will not be repeated herein for brevity.

In some embodiments, the communication device 600 may be the terminal device of some embodiments of the present disclosure, and the communication device 600 may implement a corresponding process implemented by the terminal device in the various methods of some embodiments of the present disclosure, which will not be repeated herein for brevity.

FIG. 10 is a schematic structural diagram of a chip 700 according to some embodiments of the present disclosure. The chip 700 includes a processor 710 capable of calling and running a computer program from a memory to implement the method in some embodiments of the present disclosure.

In some embodiments, the chip 700 may further include a memory 720. The processor 710 may capable of calling and running a computer program from a memory to implement the method in some embodiments of the present disclosure.

In some embodiments, the memory 720 may be a separate device from the processor 710 or may be integrated in the processor 710.

In some embodiments, the chip 700 may further include an input interface 730. The processor 710 may control the input interface 730 to communicate with other devices or chips, specifically, to obtain information or data sent by other devices or chips.

In some embodiments, the chip 700 may further include an output interface 740. The processor 710 may control the output interface 740 to communicate with other devices or chips, specifically, to output information or data to the other devices or chips.

In some embodiments, the chip may be applied to the UDM in some embodiments of the present disclosure, and the chip may implement a corresponding process implemented by the UDM in the various methods of embodiments of the present disclosure, which will not be repeated herein for brevity.

In some embodiments, the chip the chip may be applied to the terminal device in some embodiments of the present disclosure, and the chip may implement a corresponding process implemented by the terminal device in the various methods of some embodiments of the present disclosure, which will not be described herein for brevity.

It should be understood that the chips mentioned in the embodiments of the present disclosure may also be called a system-level chip, a system chip, a chip system or a system-on chip, etc.

The above-mentioned processor may be a general-purpose processor, a digital signal processor (DSP), a field programmable gate array (FPGA), an application specific integrated circuits (ASIC) or other programmable logic device, transistor logic device, discrete hardware component, etc. In some embodiments, the above-mentioned general processor may be a micro-processor or any conventional processor.

The above-mentioned memory may be volatile memory or nonvolatile memory, or may include both volatile and nonvolatile memory. In some embodiments, the non-volatile memory may be read-only memory (ROM), programmable read-only memory (PROM), erasable programmable read-only memory (EPROM), electrically EPROM (EEPROM) or flash memory. The volatile memory may be random access memory (RAM).

It should be understood that the above memories are exemplary but not limiting descriptions, for example, the memory in some embodiments of the present disclosure may also be static RAM (SRAM), dynamic RAM (DRAM), synchronous DRAM (SDRAM), double data rate SDRAM (DDR SDRAM), enhanced SDRAM (ESDRAM), synchronous link DRAM (SLDRAM), and direct Rambus RAM (DR RAM), etc. That is, the memory in the embodiments of the present disclosure is intended to include, but is not limited to, these and any other suitable types of memories.

FIG. 17 is a schematic block diagram of a communication system 800 according to some embodiments of the present disclosure. The communication system 800 includes a terminal device 810.

In some embodiments, the communication system 800 may further include a UDM network element 820.

In some embodiments, the communication system 800 may further include a first network element, such as an AMF.

In some embodiments, the terminal device 810 may be configured to implement a corresponding function implemented by the terminal device in the methods of various embodiments of the present disclosure. The UDM network element 820 may be configured to implement a corresponding function implemented by the UDM network element in the methods of various embodiments of the present disclosure. The first network element may be configured to implement a corresponding function implemented by the first network element in the methods of various embodiments of the present disclosure. It will not be repeated herein for brevity.

In the above-mentioned embodiments, it may be implemented in whole or in part by software, hardware, firmware or any combination thereof. When implemented by software, it may be implemented in the form of a computer program product in whole or in part. The computer program product includes one or more computer instructions. When a computer program instruction is loaded and implemented on the computer, the flow or function according to the embodiment of the present disclosure is generated in whole or in part. The computer may be a general-purpose computer, a special purpose computer, a computer network, or other programmable device. The computer instruction may be stored in a computer-readable storage medium, or transferred from one computer-readable storage medium to another computer-readable storage medium. For example, the computer instruction may be transferred from a website, a computer, a server or a data center to another website, computer, server or data center through wired (such as a coaxial cable, an optical fiber, a digital subscriber line (DSL)) or wireless (such as infrared, wireless, microwave, etc.). The computer-readable storage medium may be any available medium that may be accessed by the computer or is a data storage device including a server integrated with one or more available medias, a data center, etc. The available media may be a magnetic media (for example, floppy disk, hard disk, magnetic tape), an optical media (for example, DVD), or a semiconductor media (for example, solid state disk, SSD), etc.

It should be understood that in various embodiments of the present disclosure, the size of the serial numbers of the above processes does not mean an execution order, and the execution order of each process should be determined by its function and internal logic, and should not constitute any limitation on the implementation process of the embodiments of the present disclosure.

It will be clear to those skilled in the art that for the convenience and brevity of the description, the specific working processes of the systems, devices and units described above can be referred to the corresponding processes in the preceding method embodiments and will not be repeated herein.

The foregoing is only a specific implementation of the present disclosure, but the scope of the present disclosure is not limited thereto, and any changes or substitutions that can be readily thought of by those skilled in the art within the scope of the technology disclosed in the present disclosure shall be covered by the scope of the present disclosure. Therefore, the scope of the present disclosure shall be stated to be subject to the scope of the claims.

What is claimed is:

1. A terminal device, comprising a processor and a memory; wherein the memory is configured to store a computer program, and the processor is configured to call and run the computer program stored in the memory to perform:
determining, by the terminal device, a first Public Land Mobile Network PLMN according to first slice information, and accessing the first PLMN.

2. The terminal device according to claim 1, wherein the first PLMN is a PLMN supporting at least one first target slice requested by the terminal device.

3. The terminal device according to claim 1, wherein
the first slice information comprises:
N first target slices requested by the terminal device and N second PLMN information respectively corresponding to the N first target slices, and N is an integer greater than or equal to 1; or
the first slice information comprises:
second PLMN information received by the terminal device;
wherein the second PLMN information is configured to indicate at least one second PLMN determined based on second slice information.

4. The terminal device according to claim 3, wherein i-th second PLMN information in the N second PLMN information is configured to indicate at least one second PLMN rejecting a corresponding slice thereof, and i is a positive integer less than or equal to N.

5. The terminal device according to claim 4, wherein the processor is further configured to perform:
determining and/or updating, by the terminal device, the first slice information according to the second slice information, wherein the second slice information is configured to indicate at least one slice rejected by a third PLMN.

6. The terminal device according to claim 5, wherein
the processor is further configured to perform:
transmitting, by the terminal device, a first registration request to a first network element in the third PLMN;
obtaining, by the terminal device, second slice information in a first registration acceptance message in a case that the first registration acceptance message transmitted by the first network element is received; or
the processor is further configured to perform:
transmitting, by the terminal device, a first registration request to the first network element in the third PLMN;
obtaining, by the terminal device, second slice information in a first registration rejection message in a case that the first registration rejection message transmitted by the first network element is received.

7. The terminal device according to claim 4, wherein
the determining, by the terminal device, a first Public Land Mobile Network PLMN according to first slice information, comprises:
determining, by the terminal device, the first PLMN according to the N first target slices and the first slice information; or
the determining, by the terminal device, the first PLMN according to the N first target slices and the first slice information, comprises:
determining, by the terminal device, N second PLMN information corresponding to the N first target slices in the first slice information; and
determining, by the terminal device, the first PLMN based on the N second PLMN information.

8. The terminal device according to claim 7, wherein the determining, by the terminal device, the first PLMN based on the N second PLMN information, comprises:
determining, by the terminal device, the first PLMN in at least one candidate PLMN of other candidate PLMN except for the PLMN indicated by the N second PLMN information.

9. The terminal device according to claim 8, wherein the determining, by the terminal device, the first PLMN based on the N second PLMN information, further comprises:
determining, by the terminal device, the first PLMN in the at least one candidate PLMN according to a priority of each first target slice in the N first target slices, in case that there is no candidate PLMN in the at least one candidate PLMN different from the PLMN indicated by the N second PLMN information.

10. The terminal device according to claim 3, wherein the processor is further configured to perform:
transmitting, by the terminal device, a first registration request to the first network element in a third PLMN, wherein the first registration request is configured to indicate the terminal device to request a second target slice, and the second target slice is configured to determine the second slice information;
obtaining, by the terminal device, second PLMN information in a first registration acceptance message in a case that the first registration acceptance message transmitted by the first network element is received.

11. The terminal device according to claim 10, wherein the second slice information is configured to indicate at least one of the second target slice, a slice allowed by the third PLMN, and a slice rejected by the third PLMN; and
the first registration request is configured to cause the first network element to transmit the second slice information to a unified data management network element UDM, such that the second PLMN information determined by the UDM based on the second slice information is obtained.

12. The terminal device according to claim 3, wherein the determining, by the terminal device, a first Public Land Mobile Network PLMN according to first slice information, comprises:
determining, by the terminal device, the first PLMN in the at least one second PLMN.

13. The terminal device according to claim 3, wherein j-th second PLMN information in the N second PLMN information is configured to indicate at least one second PLMN supporting a corresponding slice thereof, and j is a positive integer less than or equal to N.

14. The terminal device according to claim 13, wherein the processor is further configured to perform:
determining and/or updating, by the terminal device, the first slice information according to the received second slice information transmitted by a second network element in the third PLMN;
wherein the second slice information is configured to indicate at least one slice supported by the third PLMN.

15. A unified data management network element, comprising: a processor and a memory;
wherein the memory is configured to store a computer program, and the processor is configured to call and run the computer program stored in the memory to perform:
receiving, by the unified data management network element UDM, second slice information from a first network element in a third Public Land Mobile Network PLMN; and
determining, by the UDM, second PLMN information according to the second slice information, and transmitting the second PLMN information to a terminal device, wherein the second PLMN information is used to determine a first PLMN by the terminal device, for accessing the first PLMN.

16. The unified data management network element according to claim 15, wherein the second slice information is configured to indicate at least one of a second target slice requested by the terminal device, a slice allowed by the third PLMN, and a slice rejected by the third PLMN.

17. The unified data management network element according to claim 15, wherein the second PLMN information is carried by steering of Roaming IE transmitted by the UDM.

18. The unified data management network element according to claim 17, wherein the transmitting the second PLMN information to a terminal device, comprises:
transmitting the steering of Roaming IE to the first network element, such that the first network element carries the steering of Roaming IE in a registration acceptance message and transmits the registration acceptance message to the terminal device.

19. A first network element, comprising: a processor and a memory; wherein the memory is configured to store a computer program, and the processor is configured to call and run the computer program stored in the memory to perform:
transmitting, by the first network element in a third Public Land Mobile Network PLMN, second slice information to a unified data management network element UDM;
wherein the second slice information is used by the UDM to determine second PLMN information and transmit the second PLMN information to a terminal device, and the second PLMN information is used to determine a first PLMN by the terminal device, for accessing the first PLMN.

20. The first network element according to claim 19, wherein the second slice information is configured to indicate at least one of a second target slice requested by the terminal device, a slice allowed by the third PLMN, and a slice rejected by the third PLMN.
